(19) United States
(12) Patent Application Publication
(10) Pub. No.: US 2017/0072627 A1
(43) Pub. Date: Mar. 16, 2017

(54) 3D PRINTING DEVICE AND METHOD

(71) Applicant: BOE TECHNOLOGY GROUP CO., LTD., Beijing (CN)

(72) Inventor: Wenbo LI, Beijing (CN)

(73) Assignee: BOE TECHNOLOGY GROUP CO., LTD., Beijing (CN)

(21) Appl. No.: 15/124,663

(22) PCT Filed: Aug. 20, 2015
(86) PCT No.: PCT/CN2015/087682

§ 371 Date: Sep. 8, 2016

(30) Foreign Application Priority Data
Apr. 24, 2015 (CN) 201510201691.6

(51) Int. Cl. B29C 67/00; B33Y 30/00; B33Y 50/02; B33Y 10/00

(52) U.S. Cl. CPC B29C 67/007; B29C 67/0088; B33Y 10/00; B33Y 30/00; B33Y 50/02

(57) ABSTRACT

The disclosure relates to a 3D printing device and printing method. The 3D printing device comprises: a liquid storage tank for holding a liquid photo polymerizable material; a liquid crystal display screen; a light source system, the light from the light source system transmits through the liquid crystal display screen to the liquid photo polymerizable material; a lifter pallet disposed in the liquid storage tank, the lower surface of the lifter pallet and the bottom of the liquid storage tank form a cavity, the liquid photo polymerizable material flows into the cavity along with the upward movement of the lifter pallet; a display control device for driving the liquid crystal display screen, the light source system and the lifter pallet respectively. The curing equipment in the 3D printing device has a short light path and a low graphic deformation rate, thus significantly improves the molding precision of 3D printing.

### RELATED APPLICATIONS

The present application is the U.S. national phase entry of PCT/CN2015/087682 with an International filing date of Aug. 20, 2015, which claims the benefit of Chinese Application No. 201510201691.6, filed on Apr. 24, 2015, the entire disclosures of which are incorporated herein by reference.

### TECHNICAL FIELD

The disclosure relates to the field of three-dimensional technology, and in particular, to a 3D printing device and method.

### BACKGROUND ART

With the development of three-dimensional technology, 3D (three dimensional) printing technology is also developing rapidly. The existing 3D printing technology is divided basically into three categories: hot melt plastic base technology, laser sintering molding technology and light curing liquid resin selective area curing molding technology.

In general, the light curing liquid resin selective area curing molding technology uses a projector as the curing device. However, in an actual process, the projector's light path is rather long, its light passing through many imaging lens will produce an image that has optical distortions, so cannot guarantee the accuracy of manufacture.

### SUMMARY

In order to solve the problem of the prior art, some embodiments provide a 3D printing device and method. According to an aspect, a 3D printing device is provided, the device comprising:

a liquid storage tank with a transparent tank bottom for holding a liquid photo polymerizable material;

a liquid crystal display screen disposed beneath the liquid storage tank;

a light source system disposed beneath the liquid crystal display screen, the light from the light source system transmits through the liquid crystal display screen and the underside of the liquid storage tank to the liquid photo polymerizable material;

a lifter pallet, the lower surface of the lifter pallet and the bottom of the liquid storage tank form a cavity, the liquid photo polymerizable material in the liquid storage tank flows into the cavity along with the upward movement of the lifter pallet;

a display control device for controlling the liquid crystal display screen, light source system and lifter pallet.

According to another aspect, a 3D printing method is provided, which is applied to the 3D printing device above. The method comprises:

slicing up the 3D image of an object to be printed so as to generate a plurality of 2D images;

conducting image processing to the image regions and non-image regions of the plurality of 2D images to obtain a plurality of slice images, the image region of each slice image is white, while the non-image region is black;

displaying the plurality of slice images on the liquid crystal display screen one by one;

for each slice image displayed on the liquid crystal display screen:

the display control device controls the light source system to expose the images displayed on the liquid crystal display screen, and in the exposure process, the light from the light source system passes through the white image region of the slice image to irradiate to the underside of the liquid storage tank, so that the liquid photo polymerizable material between the lifter pallet and the liquid storage tank underside polymerizes and cures, forming a cross-section layer of the object,

stop the image display and exposure processing,

move the lifter pallet upward so that the liquid photo polymerizable material in the liquid storage tank flows into a cavity between the lifter pallet and the liquid storage tank bottom.

The technical solution provided by the embodiments has one of the following beneficial effects or other effects:

With the liquid crystal display screen and the light source system that provides light to the liquid crystal display screen acting as a curing equipment of the 3D printing device, the curing equipment in the 3D printing device is improved, and the improved curing equipment has a short light path, and a low graphic deformation rate, so the molding precision of 3D printing is significantly improved.

### BRIEF DESCRIPTION OF THE DRAWINGS

In order to more clearly illustrate the technical solutions in the embodiments, the drawings to be used in describing the embodiments will be given a simple introduction below, and apparently, the drawings described below are only some examples, a person having ordinary skill in the art may obtain other variations and embodiments without having to make any creative effort.

FIG. 1 is a schematic diagram of the structure of the 3D printing device according to an embodiment;

FIG. 2 is a schematic diagram of the structure of the 3D printing device according to another embodiment;

FIG. 3 is a schematic diagram of the structure of a display control device 106 according to an embodiment;

FIG. 4 is a flow chart of a 3D printing method according to an embodiment;

FIG. 5 is a flow chart for processing a slice image according to an embodiment.

### DETAILED DESCRIPTION

In order to make the objectives, technical solutions and advantages of the embodiments more clear, the embodiments are further described in details in combination with the drawings.

FIG. 1 is a schematic diagram of the structure of a 3D printing device provided by an embodiment. As shown in FIG. 1, the device comprises: a liquid storage tank 101 with a transparent tank bottom, a liquid crystal display screen 103, a light source system 104, a lifter pallet 105 and a display control device 106.

The liquid storage tank 101 with a transparent tank bottom is used for holding a liquid photo polymerizable material 102. The liquid crystal display screen 103 is disposed beneath the liquid storage tank 101. The light source system 104 is disposed beneath the liquid crystal display screen 103. The light from the light source system 104 transmits through the liquid crystal display screen 103 and the underside of the liquid storage tank 101 to the liquid photo polymerizable material 102. The lifter pallet 105 is inside the liquid storage tank 101. The lower surface of the lifter pallet 105 and the bottom of the liquid storage tank 101 form a cavity. The liquid photo polymerizable material in the liquid storage tank flows into the cavity along with the upward movement of the lifter pallet. The display control device 106 is connected respectively to the liquid crystal display screen 103, the light source system 104 and the lifter pallet 105, for driving the liquid crystal display screen 103, the light source system 104 and the lifter pallet 105 respectively.

An embodiment provides a 3D printing device which, with the liquid crystal display screen and the light source system that provides light to the liquid crystal display screen acting as a curing equipment of the 3D printing device, improves the curing equipment in the 3D printing device, and the improved curing equipment has a short light path, and a low graphic deformation rate, thus significantly improves the molding precision of 3D printing.

The FIG. 1 above provides only a brief structure of the 3D printing device. In order to further illustrate the above 3D printing device, the respective structural parts are introduced as follows:

According to an embodiment, the liquid storage tank 101 has a transparent tank bottom, which enables the light emitted from the liquid crystal display screen 103 beneath the liquid storage tank 101 to project onto the liquid photo polymerizable material 102 held in the liquid storage tank 101, so that the liquid photo polymerizable material 102 can take shape according to the image shown by the liquid crystal display screen 103. In an embodiment, the material of the transparent tank bottom to may be a material of low UV absorption, such as transparent film, transparent resin, and etc.

Besides, in order to make sure that the printout peels off timely from the liquid storage tank 101 so as not to affect the subsequent overlay printing, a surface treatment should be conducted to the inside bottom of the liquid storage tank 101, so that the inside bottom of the liquid storage tank 101 has a cured film. The cured film is obtained by spin coating and heating up a polydimethylsiloxane (PDMS) liquid material on the inside bottom. Specifically, the formation process of the cured film may comprise: drop a PDMS liquid material to the inside bottom of the liquid storage tank 101 in advance, spin coat, make sure the coating thickness is uniform, heat it up, and form a cured film. It should be noted that, the heating can be carried out in an oven, the temperature can be 60˜100 degrees Celsius. In an embodiment, the temperature can be 80 degrees Celsius, the length of heating time can be 15-30 minutes. It should be noted that, controlling the heating temperature between 60˜100 degrees Celsius can make the PDMS liquid material successfully solidify into a film, thus avoiding the situation where the temperature is too high or too low that results in not taking shape. In addition, this heating time length can prevent such possibilities as yellow edge or curling in the film forming process, so the formed curing film is smooth, thereby ensuring the timely release of the printout.

The liquid photo polymerizable material 102 in the liquid storage tank 101 may be polymerizable liquid resin and etc.

According to an embodiment, the polarizer on the substrate proximate to the liquid storage tank 101 in the liquid crystal display screen 103 may be a high permeability polarizer (POL), so as to improve the transmittance of light emitted from the light source system 104 on the liquid crystal display screen. It should be noted that, this liquid crystal display screen shall not contain Haze or other devices that allow light scattering.

According to an embodiment, the light source system 104 can use a UV (Ultraviolet Rays) light source with a wavelength in the range of 375-445 nm. In an embodiment, the light source system adopts a LED (lighting emitting diode) UV light source with a wavelength in the range of 375-405 nm. The light source in the wavelength of 375-445 nm has a higher transmittance on the liquid crystal display screen 103, and the overall power consumption of the light source system 104 is fairly low, and a power consumption 1-10% of the projector is enough to meet the curing conditions of liquid photo polymerizable material 102, thus being energy saving.

Further, the light source system 104 is a side entry type backlight source, a straight down type backlight source or a light source formed by various lenses combined. Specifically, the side entry type backlight source comprises a side entry light source, a bottom back, a light guide plate, a diffusion film, a prism film. The direct down type backlight source comprises an array light source, a lower diffusion film, a prism film and an upper diffusion film. The light source system 104 can form point light sources or linear light sources into a uniform surface light source, so as to provide uniform incident light for the liquid crystal display screen disposed above it. Of course, in addition to the above structure, the light source system 104 may further employ other structures for providing a surface light source. The embodiment is not limited here.

According to an embodiment, the lifter pallet 105 can comprise a lifter part and a pallet part. The lifter part is to be controlled by the display control device 106 to move the pallet part up and down, and the shape of the pallet part can match with the liquid storage tank 101. The inner diameter of the liquid storage tank 101 is greater than the size of the pallet part so that the liquid held in the liquid storage tank 101 can flow into the cavity between the lifter pallet 105 and the bottom of the liquid storage tank 101 through the gap determined by this difference in size.

According to an embodiment, the display control device 106 can be a computer device with image processing, data processing capability and controlling capability. Of course, the display control device 106 can be a whole equipment, such as the aforementioned computer device, but may also be at least two independent devices called by a joint name. For example, the display control device 106 may comprise an image processing device, a data processing device and a control device. The three devices may have a connection relationship therebetween, making the display control device 106 have the ability to drive the liquid crystal display screen 103, the light source system 104 and the lifter pallet 105.

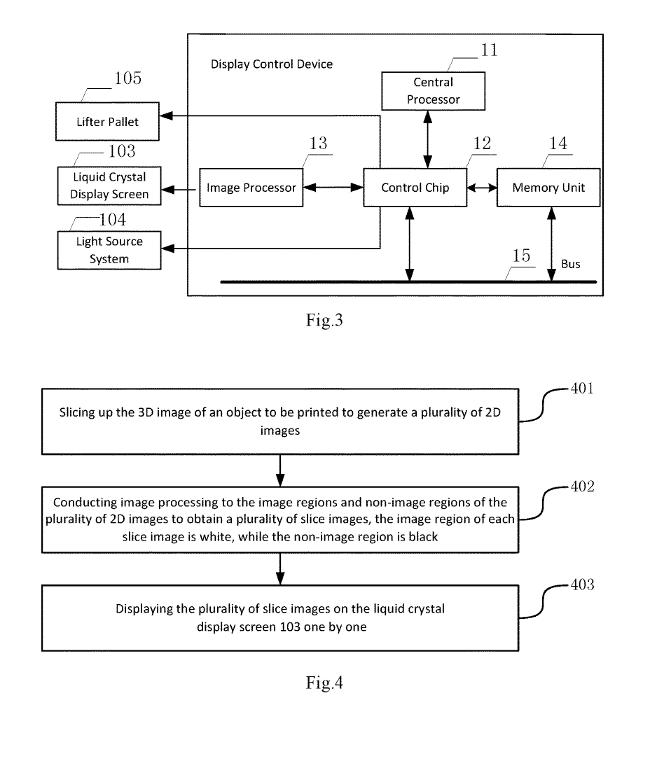

FIG. 3 is a schematic diagram of the structure of a display control device 106 according to an embodiment. As shown in FIG. 3, the display control device 106 comprises the following structure: a central processor 11, a control chip 12, an image processor 13, a memory unit 14, and a bus 15. The control chip 12 is connected respectively with the central processor 11, the control chip 12, the image processor 13, the memory unit 14, and the control chip 12 can interact with the memory unit 14 through the bus 15.

The image processor 13 can be used for dividing the 3D image of the object to obtain multiple 2D images, then conducting image processing to the multiple 2D images to obtain multiple slice images and store the multiple slice images to the memory unit 14.

Specifically, combined with the structure of the above display control device, the following is a description of the specific process of how the display control device 106 drives the liquid crystal display screen 103, the light source system 104 and the lifter pallet 105 during the 3D printing process: When operating a 3D printing device, the user often gives a print instruction through an input device (such as a keyboard or display interface control buttons), to send a first instruction signal to the central processor 11. The central processer 11 receives the first instruction signal and sends a second instruction signal to the control chip 12. The control chip 12 receives the second instruction signal, sends a driving signal to the image processor 13 and through the bus 15 sends a slice image of the object stored in the memory unit 14 to the image processor 13. The image processor 13 receives the driving signal, processes the slice image and sends the processed slice image to the liquid crystal display screen to be displayed. At this point, the control chip 12 can provide output to the liquid crystal display screen according to a certain sequence, and synchronized instructions can be sent to the 3D lifter pallet 105 and light source system 104 at the same time so as to allow the light source system 104 provide backlight source for liquid crystal display screen when the liquid crystal display screen is displaying images.

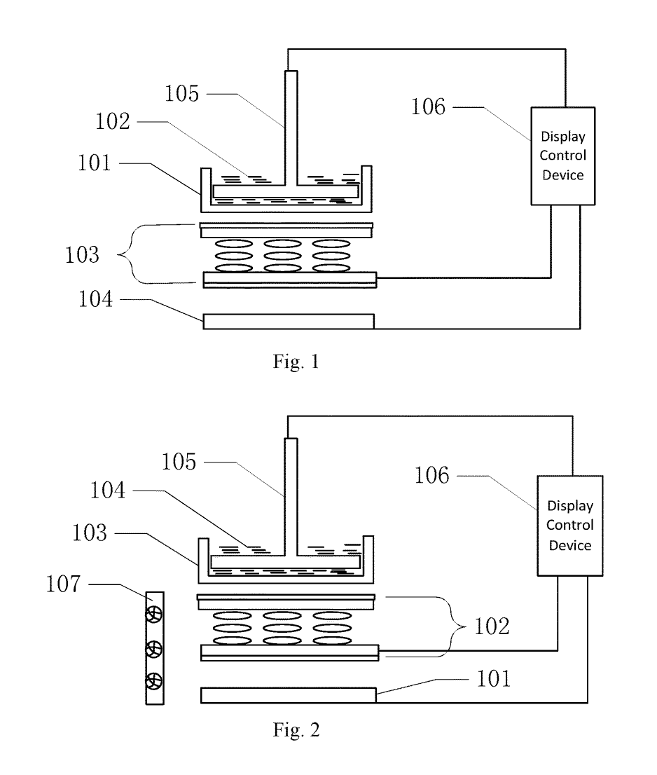

According to another embodiment, the 3D printing device may also comprise a cooling device 107 for cooling the light source system 104 and the liquid crystal display screen 103. The cooling device 107 can be disposed around the light source system 104 and the liquid crystal display screen 103 (as shown in FIG. 2). Optionally, an implementation of the cooling device 107 is a fan. In the working process of the 3D printing device, the cooling device 107 can be used to cool off the light source system 104 and the liquid crystal display screen 103 in a timely manner to avoid the damage caused by overheating, and the service life of the device can be effectively improved.

It should be noted that all of the above optional technical solutions can use any combination to form the optional embodiments, which will not be discussed one by one herein.

The embodiments provide a 3D printing method based on the structure of the 3D printing device provided in FIG. 2 above. FIG. 4 is a flow chart of a 3D printing method according to an embodiment. As shown in FIG. 4, this method specifically comprises:

401. slicing up the 3D image of an object to be printed to generae a plurality of 2D images.

In the process of 3D printing, as the printing process needs to print the object layer by layer, it is necessary to first establish 3D CAD entity data model or sculptured surface data model for the object to be printed, use the obtained model data file as the 3D image of the object to be printed, slice up the 3D image according to the printing thickness set by the 3D printing device itself to generate a plurality of 2D images. The 3D image of the object can be the .stl file format. The software specifically adopted to slice up the 3D image can be any software with the slicing function, which will not be discussed herein.

It should be explained that, for different 3D printing devices, the printing thickness can be different, so when slicing, the number of 2D images obtained can also be different.

Before carrying out 3D printing, in order to make sure that the printout peels off timely from the liquid storage tank 101 so as not to affect the subsequent overlay printing, a surface treatment should be conducted to the inside bottom of the liquid storage tank 101, so that the inside bottom of the liquid storage tank 101 has a cured film. The cured film is obtained by spin coating and heating up a polydimethylsiloxane (PDMS) liquid material on the inside bottom. Specifically, the formation process of the cured film may comprise: drop a PDMS liquid material to the inside bottom of the liquid storage tank 101 in advance, spin coat, make sure the coating thickness is uniform, heat it up, and form a cured film. It should be noted that, the heating can be carried out in an oven, the temperature can be 60˜100 degrees Celsius. In an embodiment, the temperature can be 80 degrees Celsius, the length of heating time can be 15-30 minutes.

402. conducting image processing to the image regions and non-image regions of the plurality of 2D images to obtain a plurality of slice images, the image region of each slice image is white, while the non-image region is black.

Because the projector equipment adopted in the embodiment is a liquid crystal display screen 103 and a light source system 104, in order to make the image displayed by the liquid crystal display screen 103 capable of causing the liquid polymerizable material in the liquid storage tank to polymerize and cure, it is necessary to process the 2D image. The image region in the 2D image is processed to be white, so that the light of the light source system can transmit through this image region to irradiate on the liquid polymerizable material to make it polymerize and cure. The non-image region in the 2D image is processed to be black, so that the light of the light source system will not transmit through this non-image region, i.e., will not irradiate on the liquid polymerizable material.

403. Displaying the multiple slice images on the liquid crystal display screen 103 one by one.

This one-by-one display process means to display the multiple slice images according to a certain sequence. The display time of each slice image is a preset display time. A person having ordinary skill in the art can understand that the above steps 401-403 can be performed by the display control device 106 or by an image processing device or a data processing device which can run a predetermined program.

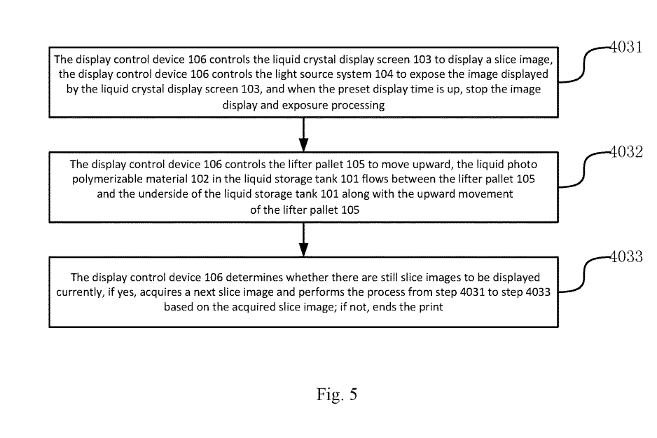

Specifically, see FIG. 5, the image processing procedure of a slice image is taken as an example for illustration, including the following steps 4031-4033:

4031. The display control device 106 controls the liquid crystal display screen 103 to display a slice image, the display control device 106 controls the light source system 104 to expose the image displayed by the liquid crystal display screen 103, and when the preset display time is up, stop the image display and exposure processing.

When preparing for an exposure, the lifter of the 3D printing device has completed homing, the light source system 104 switches on, the moment the liquid crystal display screen 103 begins to display the slice image is the time to start the exposure of the polymeric material. After the completion of one exposure, the display control device 106 controls the light valve of the liquid crystal display screen 103 to switch off (i.e., input a black signal) or/and switch off the light source system 104, to ensure that the liquid polymerizable material is not exposed by mistake before printing a next slice image.

The display time of each slice image is just the exposure time, so can realize a positive exposure. The preset display time can be set and adjusted by the display control device. Optionally, the preset display time for each slice image can be determined according to the specific molding speed of the liquid polymerizable material. Different liquid polymerizable materials may correspond to different molding speeds. Therefore, the preset display time for said slice image may change with different liquid polymerizable materials, and may be adjusted by the display control device.

In the exposure processing procedure, the light from the light source system 104 passes through the white image region of the slice image to irradiate to the underside of the liquid storage tank 101, causing the liquid photo polymerizable material between the lifter pallet 105 and the underside of the liquid storage tank 101 to polymerize and cure, to form a cross-section layer of the object. Then, the image display and exposure processing is stopped. Optionally, stopping the image display and exposure processing comprises: a display control device 106 turns off the display valve of the liquid crystal display screen 103 or inputs a black signal to the liquid crystal display screen 103 or turns off a backlight source of the light source system 104.

4032. The display control device 106 controls the lifter pallet 105 to move upward, the liquid photo polymerizable material 102 in the liquid storage tank 101 flows between the lifter pallet 105 and the underside of the liquid storage tank 101 along with the upward movement of the lifter pallet 105.

When a slice image printing has been completed, one may pause for a certain period of time, and in this pause time period the display control device 106 controls the lifter pallet to move upward and return home to ensure and control the influx of liquid polymerizable material of the next exposure, completing the preparatory work for the next exposure.

4033. The display control device 106 determines whether there are still slice images to be displayed currently, if yes, acquires a next slice image and performs the process from step 4031 to step 4033 based on the acquired slice image; if not, ends the print.

In the course of the above steps 4031-4033, the light source system 104 turns point light sources or linear light sources into a uniformly distributed surface light source. The surface light source is directly projected onto the liquid photo polymerizable material 102 in the liquid storage tank 101 through the slice image of the liquid crystal display screen. The very thin liquid photo polymerization material 102 between the lifter pallet 105 and the inside bottom of the liquid storage tank 101 polymerizes and cures under the transmitted irradiation of the liquid crystal display screen 103, completing an exposure of the cross-section slice image, and obtaining a cured and molded cross-section layer. The lifter pallet 105 lifts the cured and molded cross-section layer up, allowing the liquid photo polymerizable material 102 to add in, then performs the display and exposure processing to the next slice image, thus the thin layer between the lifter pallet 105 and inside bottom of the liquid storage tank 101 once again is exposed through the above steps. The same procedure goes on until all the slice images have been performed the display and exposure processing, thus completing the layer-by-layer curing overlay printing of the 3D object. It should be noted that when the lifter pallet 105 moves upward, the moving distance can be greater than the necessary slice thickness. Subsequently, the display control device 106 may control the lifter pallet 105 to fall again, so as to use pressure to expel some liquid from the cavity formed by the lower surface of the lifter pallet 105 and the inside bottom of the liquid storage tank 101 to ensure the cavity has appropriate amount of liquid to achieve exposure curing.

Optionally, in the above printing process, a cooling device 107 can be used for the light source system 104 and the liquid crystal display screen 103 to carry out heat radiation, wherein the cooling device can be a fan.

Optionally, the material of the transparent tank bottom of the liquid storage tank is transparent film, or transparent resin.

Optionally, the polarizer on the substrate proximate to the liquid storage tank in the liquid crystal display screen may be a high permeability polarizer.

Optionally, the light source system adopts a UV light source with a wavelength of 375-445 nm. In an embodiment, a LED UV light source with a wavelength of 375-405 nm is adopted in the light source system.

A person having ordinary skill in the art can understand that all or part of the steps of the embodiments above can be performed by hardware, or by a program instructing the related hardware to complete. The program can be stored in a computer readable storage medium. The above mentioned storage medium can be a read-only memory, a magnetic disk or an optical disk and so on.

The above are only optional embodiments of the present invention, being not intended to limit the invention. Any modifications, equivalent replacements, improvements and the like within the spirits and principles of the present invention shall be included in the scope of protection of this invention.

1. A 3D printing device, wherein the device comprises:
a liquid storage tank with a transparent tank bottom for holding a liquid photo polymerizable material;
a liquid crystal display screen disposed beneath the liquid storage tank;
a light source system disposed beneath the liquid crystal display screen, the light from the light source system transmits through the liquid crystal display screen and the underside of the liquid storage tank to the liquid photo polymerizable material;
a lifter pallet, the lower surface of the lifter pallet and the bottom of the liquid storage tank form a cavity, the liquid photo polymerizable material in the liquid storage tank flows into the cavity along with the upward movement of the lifter pallet;
a display control device for controlling the liquid crystal display screen, light source system and lifter pallet.

2. The 3D printing device of claim 1, wherein the 3D printing device further comprises a cooling device disposed around the light source system or the liquid crystal display screen.

3. The 3D printing device of claim 2, wherein the cooling device comprises a fan.

4. The 3D printing device of claim 1, wherein the material of the transparent tank bottom of the liquid storage tank comprises transparent film or transparent resin.

5. The 3D printing device of claim 1, wherein the polarizer on the substrate proximate to the liquid storage tank in the liquid crystal display screen comprises a high permeability polarizer

6. The 3D printing device of claim 1, wherein the light source system adopts a UV light source with a wavelength of 375-445 nm.

7. The 3D printing device of claim 1, wherein the light source system adopts a LED UV light source with a wavelength of 375-405 nm.

8. The 3D printing device of claim 1, wherein the inside bottom of the liquid storage tank has a cured film.

9. The 3D printing device of claim 8, wherein the cured film is obtained by spin coating and heating up a polydimethylsiloxane liquid material on the inside bottom

10. The 3D printing device of claim 9, wherein the heating temperature is 60˜100 degrees Celsius in the process of forming the cured film.

11. The 3D printing device of claim 10, wherein the heating temperature is 80 degrees Celsius in the process of forming the cured film.

12. The 3D printing device of claim 9, wherein the length of heating time is 15-30 minutes in the process of forming the cured film.

13. A 3D printing method, wherein the 3D printing method is applied to the 3D printing device of claim 1, the method comprising:
slicing up the 3D image of an object to be printed to generate a plurality of 2D images;
conducting image processing to the image regions and non-image regions of the plurality of 2D images to obtain a plurality of slice images, the image region of each slice image is white, while the non-image region is black;
displaying the plurality of slice images on the liquid crystal display screen one by one;
for each slice image displayed on the liquid crystal display screen:
the light source system exposes the images displayed on the liquid crystal display screen, and in the exposure process, the light from the light source system passes through the white image region of the slice image to irradiate to the underside of the liquid storage tank, so that the liquid photo polymerizable material between the lifter pallet and the liquid storage tank underside polymerizes and cures, forming a cross-section layer of the object,
stopping the image display and exposure processing,
moving the lifter pallet upward so that the liquid photo polymerizable material in the liquid storage tank flows into a cavity between the lifter pallet and the liquid storage tank bottom.

14. The 3D printing method of claim 13, wherein stopping the image display and exposure processing comprises: turning off the display valve of the liquid crystal display screen or inputting a black signal or turning off a backlight source.

15. The 3D printing method of claim 13, wherein the lifter pallet 105 is moved upward for a distance greater than the slice thickness.
